(19) United States
(12) Patent Application Publication
(10) Pub. No.: US 2023/0002018 A1
(43) Pub. Date: Jan. 5, 2023

(54) FLOATING PLATFORM FOR SUPPORTING GENERATORS OF POWER DERIVED FROM THE WIND AND/OR WAVES AND/OR OCEAN CURRENTS

(71) Applicants: Manuel MARTÍNEZ DE AZCOITIA FERNÁN DEZ, Gijón (ES); FIROVI, S.A., ALCOBENDAS (ES)

(72) Inventor: Manuel MARTÍNEZ DE AZCOITIA FERNÁNDEZ, GIJÓN (ES)

(21) Appl. No.: 17/777,996

(22) PCT Filed: Nov. 19, 2019
(86) PCT No.: PCT/ES2019/070788

§ 371 Date: May 18, 2022

(51) Int. Cl. B63B 35/44; B63B 17/04; B63B 39/02; B63B 3/38; F03D 7/02; F03B 13/14

(52) U.S. Cl. CPC B63B 35/44; B63B 17/04; B63B 39/02; B63B 3/38; F03D 7/0224; F03B 13/14; B63B 2035/446; B63B 2035/4466; F05B 2240/93; F05B 2220/706

(57) ABSTRACT

A floating platform for supporting generators of power derived from the wind, the waves and ocean currents, adopting an approximately disc-shaped general configuration with a circular or polygonal perimeter, which optimises its size and therefore minimises substantially its weight and likewise its production costs, as well as other associated complexities; which eliminates the possibility of entering into resonance with the movement of the ocean waves and thus not damaging the equipment installed, not overturning, and not surpassing the maximum list acceptable for wind power generators, nor wave power generators, nor ocean current generators; and which withstands the waves of the greatest size possible, all due to a ratio between its depth or height (13) and the diameter (14) thereof of between 0.06 and 0.35.

### OBJECT OF THE INVENTION

The object of the present invention, as stated in the title thereof, is a floating platform for supporting different types of power generators, adopting a generally disc-shaped configuration with a circular or polygonal perimeter, designed in such a way that it collects the wind, ocean current and wave energy in a substantially more profitable and sustainable manner than those existing to date, and without the floating platform and its equipment overturning or suffering damage.

The present invention is characterised in its particular, painstaking configuration and design, particularly its dimensions, due to which the platform is the optimal result with regard to its dimensions and costs; likewise to its hydrodynamic properties, thanks to which its stability is substantially improved.

Therefore, the present invention is included within the field of means of supporting and installing wind, wave and ocean current energy generators on the ocean surface.

### BACKGROUND OF THE INVENTION

The different methods of supporting and stabilising marine wind turbine generators may be seen in FIG. 1, wherein the following are portrayed:
(1), (2) Conventional fixed platforms;
(3) Jack-up tower platforms;
(4), (5) Tension-leg floating platforms;
(6) Spar platforms;
(7), (8) Semi-submersible platforms;
(9) Platforms on drillships;
(10) Platforms supported on underwater shelves and linked to extraction facilities on the ocean floor.

FIG. 2 portrays different mooring systems of the “spar” type, tension-leg semi-submersibles (11), while FIG. 3 portrays a platform of the “Barge” type (12) (a group to which the present invention belongs).

With regard to these, the well-known American technician Jason Jonkman states:
The “spar” type has considerable static angles of inclination which require special mechanical projects,
The “barge” type sustains greater movements of the nacelle due to the combination of wind and waves; a suitable project for the turbines is therefore necessary, which will be more costly, and the movements must be smoothed out with alternative solutions. However, when the swell diminishes, the loads are considerably reduced,
The risk of “slamming” should also be borne in mind.
The Spar type undergoes less movement; however, non-linear forces appear, which require more advanced tools,
The manufacture of these floating systems can be optimised, due to their being mass-produced,
Controls must be devised in the response of the turbine/platform combination to the random movement of the waves, such as a smart variation in the pitch of the turbine blades to reduce the fore-aft sway,

However, these platforms are complex in their execution and assembly, and also very costly, restricting considerably their scope of application and their future availability.

The prior art reveals patent ES2650275 B1, which discloses a multi-purpose disc-shaped floating platform for supporting marine wind turbine generators and other marine energy generators, which claims to be a floating platform that supports wind turbine generators or generators driven by waves and/or ocean currents or the tides, where the platform has a height-to-diameter ratio of less than 5%, stating that its weight is considerably less than that of other platforms.

Although said platform fulfils the requirement sought, it nonetheless presents a number of aspects which clearly leave room for improvement. Indeed, on the one hand, with the aforementioned height-to-diameter ratio of the platform, it must necessarily have a relatively large radius, resulting in greater dimensions, a greater quantity of material and therefore a greater environmental impact, and consequently, significantly high manufacturing, testing and transport costs. Furthermore, additional factors have not been taken into account, such as the period of the waves, which may cause the platform to enter into resonance and even overturn.

A solid, when disturbed from its resting position, tends to vibrate at certain frequencies, called natural frequencies, when excited. For each natural frequency, the solid acquires a particular shape, called mode shape. Frequency analysis calculates the natural frequencies and the associated mode shapes. When the frequency of the wave-emitting source coincides with the natural frequency of the resonator (the object that oscillates), a condition known as resonance is reached. Resonance is defined as the tendency of a physical system to oscillate with a much higher amplitude at some frequencies. If the platform amplifies its oscillation with lists of 45, 60 degrees or more, said movements might even cause the platform to overturn.

Therefore, the object of the present invention is to overcome the drawbacks stated concerning the floating disc-shaped platform disclosed in ES2650275 B1, fundamentally concerning its excessive size, and therefore costs and associated complexities, likewise the possibility of entering into resonance with the movement of the ocean waves and even overturning, by developing a platform which overcomes the aforementioned drawbacks and which takes into account all the possible factors that come into play in its stability on the ocean surface.

This platform has the characteristics described below, the essential nature whereof is described in claim 1.

### DESCRIPTION OF THE INVENTION

The object of the present invention is a floating platform for supporting marine power generators of any type and nature, either wind turbine generators, or generators that exploit the movement of the tides or the undulating movement of the waves.

It will be disc-shaped, and its perimeter may be circular or multiple-sided polygonal, this choice depending solely on the ease of construction.

It will be located by means of anchoring, and due to it being totally regular, it will present an identical surface to the waves, wherever they come from. However, the nacelle (where the wind power generator is housed) will swivel, in order to absorb the energy of the wind, from whichever direction it comes.

The power generators driven by the waves and currents will consist of devices specifically designed for this purpose, with either vertical-shaft rotors (waves) or horizontal-shaft (currents), or other devices which, located on the periphery of the platform at the height of the waterline, enable the collection of the energy foreseen to be performed.

For the design of the platform which is the object of the invention, the following factors, described below, and the inter-relationship between them, have been taken into account.
Radius (m),
Depth (height of the disc) (m),
Bulwark (non-watertight upper structure acting as a breakwater). Height in metres,
Keel (non-watertight lower structure similar to a skirt, which encloses seawater). Height in metres,
Distance between ocean surface and bulwark (m),
Draught (the part of the height of the disc that is submerged) (m),
Weight of the blades, hub and nacelle (MT),
Weight of the tower (MT),
Weight of bulwark and keel (MT),
Weight of the disc (MT) as calculated,
Volume of the disc, without keel (m3)
Fixed ballast (MT),
P=Displacement (MT) (sum of all the weights)
Inertia of the disc (π*R⁴)/4 (m4),
(Ig), Inertia of the assembly, as a sum of all the inertias with respect to the centre of gravity,
Total weight of the platform (MT) (sum of the weight of the disc plus the fixed ballast).
Angle of the wave expressed in radians, which is equal to the arc tag of the wave height divided by half the length of the wave.
Angle of list (maximum list) in degrees and radians.

For the stability study, the following have been taken into account: the action of the wind on the generator blades, the swell against the assembly, and the inter-relationship between the inertias, the centres of gravity, the flotation inertia, the metacentric height, the centre of buoyancy, etc. all given in the following expressions:
Thrust heeling lever=(distance from the centre of gravity of the generator−distance from the centre of gravity of the assembly)×thrust on the generator shaft (MT×m),
Righting lever=Displacement (P)×(distance from the metacentre−distance from the centre of gravity of the assembly)×(MT×m), expressed as P×(r−a).
T=is the period, expressed in seconds.

It is related to the mass (Ig) and the stability (P×(r−a)) by the expression:

T=k*2*π*[Ig/(P*(r−a)*g)]^{1/2}

K=being the coefficient established by various hydrodynamic tests which includes the additional inertia due to the mass of water associated with the floater in question, ship or platform, when it oscillates in the water.

Given that the period of the waves varies between 8 and 20 seconds, it has been adjudged that, at least, the period of these platforms must be greater than 15 seconds, as this is in the region of 50% more than the smallest period of the swell and is the proportion that is considered minimal to prevent phenomena of resonance.

All the above formulae and the parameters taken into account enable the design of an approximately disc-shaped floating platform that fulfils the conditions sought regarding the smallest size possible and therefore likewise costs and complexities, has an acceptable wind-caused list for the equipment installed, slamming does not occur, as it is “glued” to the ocean surface at all times, and it prevents the possibility of entering into resonance with the ocean wave movements, and thus does not damage the equipment installed and can never overturn.

In order to satisfactorily resolve the aforementioned conditions, stability calculations and a scale model test have been performed, defined by the equality of the Froude's number (which relates the forces of inertia with those of gravity and is represented by the quotient between velocity and the square root of the product of gravity by length) in a model and a prototype (according to the table below) in a hydrodynamic Test Canal with reference OTI 2460, equipped with a suitable anchoring system and using an optical monitoring system (Krypton) with an incident wave sensor, a relative wave sensor, accelerometers, load cells and cameras to film the 18 different regular and irregular surges to which the platform was subjected.

List of dimensions between model and prototype.

| DESCRIPTION | PROTOTYPE | MODEL |
|---|---|---|
| Scale | 1 | 28.57 |
| Radius [m] | 20.000 | 0.700 |
| Depth [m] | 7.620 | 0.267 |
| Draught [m] | 4.140 | 0.145 |
| Displacement [kg] | 5334254 | 223.128 |
| KG [m] | 14.470 | 0.506 |
| GM [m] | 11.750 | 0.411 |
| CDG Inertia Kg*m2] | 5950509757 | 304.909 |
| List angle [°] | 0 | 0 |
| Trim angle [°] | 0 | 0 |

Taking into account the calculations performed and the subsequent verifications in hydrodynamic tests, the floating platform presents a ratio between the depth or height of the platform and the diameter thereof, excluding the bulwarks and keels, of between 0.06 and 0.35.

In order to verify all the above calculations, a prototype was constructed and subjected to a hydrodynamic test. The first test was a so-called “extinction test”, or verification of calculations, and next the 18 different types of swell were produced, from 15 (service) to 3 (extreme or survival), overcoming all of these. The survival swells were none other than the maximum swells that occur in the North Atlantic. The aforementioned tests have proven the correct sizing of the floater, of its weight and thrust distribution, its inertias, buoyancy or response to undulating movements, its anchoring system, its vertical and horizontal accelerations, velocities, period, etc.

This test is highly significant, as it is set at the most demanding extreme, but there are many other intermediate states where the proportions may be varied to comply with requirements, and therefore we must work on a group and not a single point.

The dimensions of the platform tested were: 20 m radius, 7.62 m depth, with a bulwark of 2.87 m and a keel of 2.87 m. Draught was 4.14 m. The distance between the waterline and the top of the bulwark: 6.35 m.

This survival test was performed without generating power; the list angle caused by the wind is therefore zero.

The fact that the survival test was passed with these dimensions tells us that with the maximum incident wave measured, this being 7.33 m., the height of 6.35 m. was sufficient.

With this datum, the platform was resized for a wind thrust of 6 MW (922 kN), resulting in the following:
Radius=20.5 m.
Depth=8.36 m., plus bulwark and keel of 3 m. each, sloping at 20° and 45° from the vertical
Weight of the structure: 831 MT
Ballast: 3,500 MT
Weight of the tower and nacelle: 837 MT
Total weight with ballast: 5,168 MT
Draught: 3.82 m
Natural period: 22.23 sec.

The stability tests reveal that, when exploiting the maximum energy from the wind, there is a list of 6°. A list that is produced from the Centre of Gravity of the assembly.

As the height of the incident wave with service (not survival) swell was 6.29 m., the free height from the waterline to the top of the bulwark must be:

6.35−(7.33−6.29)=5.31 m.

Combining this distance with the 6° list, the new radius of 20.5 m. gives a depth of 8.36 m. plus bulwark and keel of 3 m. each.

The possible ratios would be:
Without bulwarks or keels: 8.36/41=0.203.
Note: It would have bulwarks and keels, but the ratio is derived from the depth divided by the diameter or length, not by the depth plus bulwark and keel.
If we raise the deck to the height of the bulwark and set it vertical: 11.36/41=0.277
If the deck is raised and the lower deck or base is lowered to the keel, setting it vertical: 14.36/41=0.350

Conversely, the depth could be reduced and the height of the keels and bulwarks increased; thus, the ratio could be reduced as deemed appropriate, although this may be unworkable.

Thus, with 0.06, the depth would be 41×0.06=2.46 m., and the bulwark would be: (14.36−2.46)/2=5.95 m., and the keel also 5.95 m., so the sum of depth+bulwark+keel=14.36 m.

These dimensions could result in an insufficient structural resistance to the impact of the waves and to undersea movements due to the excessive cantilevered height, although this solution might be chosen for small swells, with keels and bulwarks of a lesser height.

However, a similar sizing might be feasible if the power of the generator is reduced, e.g. from 6 MW to 1 MW.

Therefore, bearing in mind that the proportions are highly variable, depending on:
The swell where the platform is to be located,
the more or less intense wind conditions, and
the power to be absorbed by the generator,

It is considered that the relationship or ratio between the depth or height of the platform and the diameter thereof, this being between 0.06 and 0.35, satisfies the stability requirements that take into account all the physical variables that may affect its stability (wind, force of the swell, period of the waves, period of the platform itself, list of the assembly, etc.).

Finally, it must be stated that this platform may be considered to be 4.0 or smart, as it features some of the means described below or combinations thereof:
The rotor blades can alter their pitch according to the intensity of the wind;
automatic means for the taking on or releasing of seawater ballast to position the tilt of the platform in the direction where the wind is coming from at all times;
Cathodic protection means by impressed currents to prevent the oxidation of the hull and to maintain the protection throughout the useful life of the platform;
Means for the monitoring of the tension of the anchor chains for the remote detection of possible faults or maladjustments.
A weather station.

Unless indicated otherwise, all the technical and scientific elements used in this specification have the meaning usually understood by a person skilled in the art to which this invention belongs. In the practice of this invention, methods and materials similar or equivalent to those described in the specification may be used.

In the description and claims, the word “comprises” and its variants do not intend to exclude other technical characteristics, additives, components or steps. For persons skilled in the art, other objects, advantages and characteristics of the invention will be partly inferred from the description and partly from the practice of the invention.

### EXPLANATION OF THE FIGURES

In order to complement the description being made herein, and with the objective of better understanding the characteristics of the invention, in accordance with a preferred practical embodiment thereof, said description is accompanied, as an integral part thereof, by a set of drawings where, in an illustrative and non-limiting manner, the following has been represented:

In FIG. 1, we may see the different methods of anchoring wind turbine generators on the sea.

In FIG. 2, we may see semi-submersible “spar”-type anchorages.

FIG. 3 portrays “barge”-type platforms.

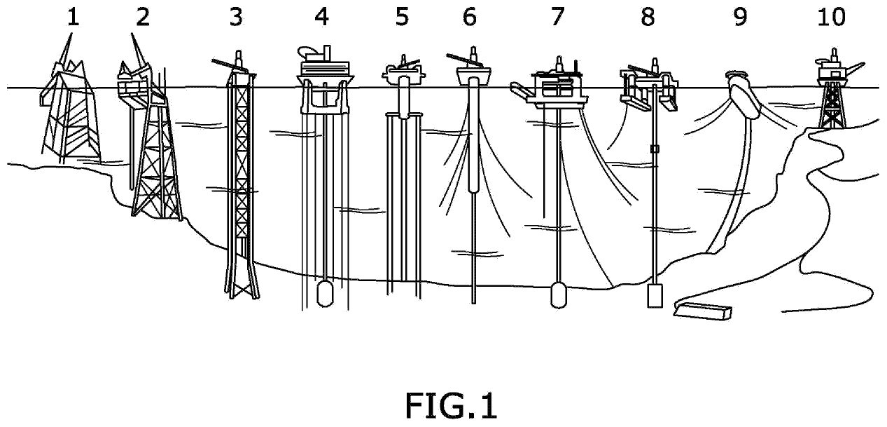

FIG. 4 portrays a lateral view of the floating platform wherein different construction aspects are referenced.

FIG. 5 portrays additional construction aspects, where the interior of a floating platform may be seen.

FIG. 6 portrays a representation of a floating disc module.

### PREFERRED EMBODIMENT OF THE INVENTION

In view of the figures, a preferred embodiment of the proposed invention is described below.

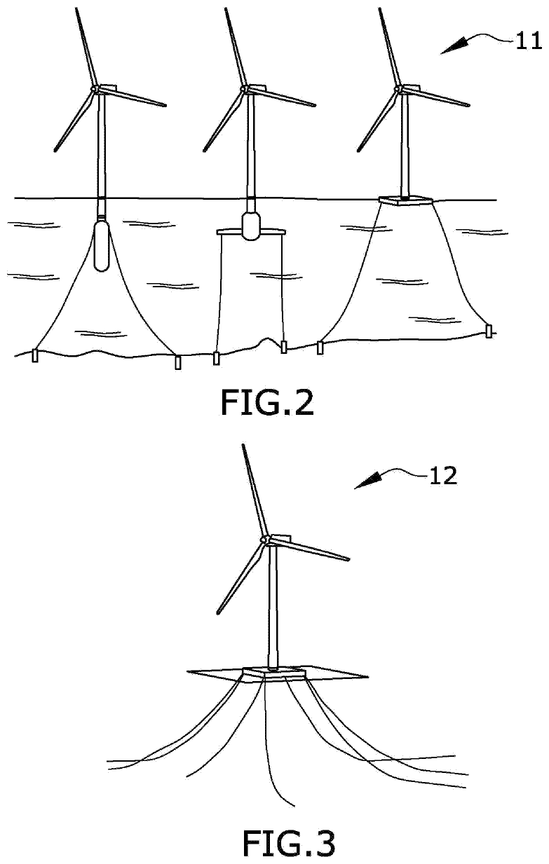

In FIG. 4 we can see a lateral view of the floating platform, showing the depth or height of the platform (13), the diameter (14), the draught (17), the distance between the water surface and the base of the platform, likewise the free distance (18), this being understood to be the distance between the surface of the sea and the upper edge of the platform. Also visible are a number of optional, additional complementary elements, consisting of sloping bulwarks or profiles (15) which surround the perimeter of the platform and prevent the entry of water to the surface thereof, and also the sloping keels or skirts (16) that provide stability.

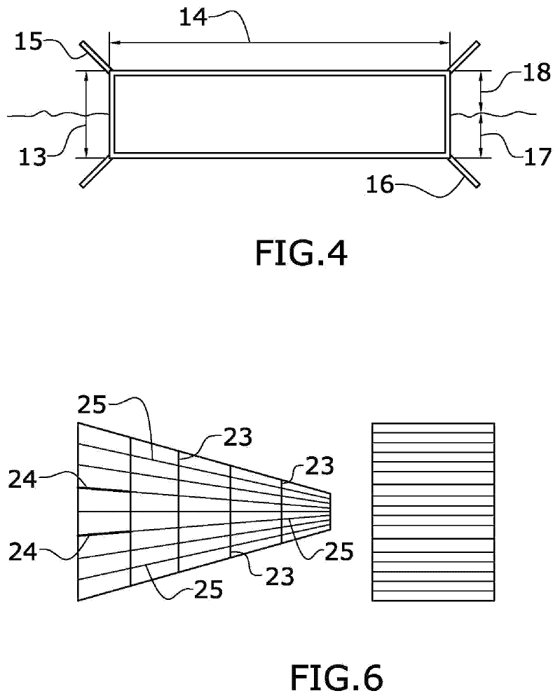

FIG. 5 portrays the structure of the floating platform which, as may be seen, consists of a series of carlings (22) disposed radially with regard to a central axis (19), where the carlings (22) are connected by means of a series of stringers (23) to endow the platform with greater structural rigidity; in addition, a series of transversal perimeter reinforcements (24), disposed in the final span of each circular section, where all the aforementioned elements are housed in the internal space defined by an external shell or external sheathing (20) to compensate the external pressure of the sea.

The tower has a series of ribs, in such a way that said element is positioned so that these are in correspondence with the carlings.

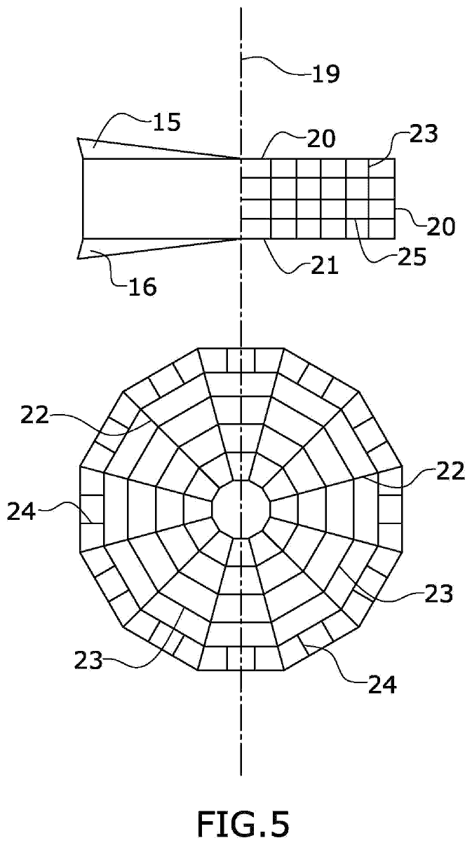

In FIG. 5 and in the detail in FIG. 6, a series of angular reinforcements or bulb flats (25) may be seen; these are disposed on the interior of the external plates. Said bulb flats (25) on the external sheathing are installed vertically, as are the ribs of ships, while on the decks and base the bulb flats (25) are installed radially in the intermediate space defined by the carlings (22). Their purpose is to reduce the opening and to reduce the thicknesses of the plate.

The platform may be constructed from Steel, Marine Steel A or glass-fibre reinforced polyester (GRP).

By way of an example, for the twelve-sided polygonal platform described above, with a radius of 20.5 m. and a height of 8.36 m., we should proceed as follows:
Material: marine steel A comprised of sheets, profiles and bulb flats,
A totally watertight radial structure, with bulwarks and keels (optional); the bulwarks will feature drains or automatic non-return bulwark ports (similar to those existing in ships) to prevent rainwater or splashes from remaining therein.
Twelve identical modules will be manufactured, although one of the modules will have two carlings (vertical structure in the direction of the radius) instead of only one, as in the rest; transversal stringers or reinforcements and longitudinal reinforcements at the extremity of the module, more bulb flats at the bases, deck and sides by way of ribs. All of this covered by the external sheathing.

These modules would be constructed in a workshop, welded with construction procedures and details

approved by a Classification Society and with careful preparation of the surfaces for the application of rust-preventive and anti-fouling paints (this last on the external submerged section—underwater body).

The twelve modules would be assembled on the shipyard slipway due to its surface area and its proximity to the sea, locating them with cranes and a construction cradle, observing the construction plan.

Finally, the watertightness tests would be performed and it would be launched into the sea.

Next, with the platform now floating, the tower and nacelle would be installed, coupling its vertical reinforcements with the carlings of the bulwark, should there be one, or on the deck, exactly in the area where the carlings are located, to endow the assembly with the appropriate structural continuity.

Finally, the assembly would be towed to its definitive offshore location.

This procedure, due to the exclusive nature of the project, saves significant installation costs.

Conversely, the platforms resting on and anchored to the ocean floor, as they do not float, involve high production costs as they require the use of a considerable tonnage of material, and furthermore, the logistics for their transfer and placement are highly complex, as they have to be transported in costly vessels especially constructed for the performance of these delicate operations.

On the other hand, floating platforms of the spar type, due to their great height and draught, must be transported lying flat and then erected to the vertical at their final location by auxiliary ships which are also complex and costly.

The floating platform which is the object of this invention, by floating and having a reduced draught, may be transported by simple towing, with no need to perform any special manoeuvre in its placement. It may be considered a “plug & play” platform, as once disposed on the sea, it is ready for use. This property of installing and operating is highly important for the logistics of this invention in comparison with those existing.

Finally, it should be mentioned that the structure may also be designed straight, with parallel carlings, modifying the connection with the tower in comparison with that described herein.

Having sufficiently described the nature of the present invention, in addition to the manner in which to put it into practice, it is hereby stated that, in its essence, it may be put into practice, as stated herein, in other embodiments that differ in detail from that indicated by way of an example, and to which the protection shall likewise apply, provided that its basic principle is not altered, changed or modified.

1. A floating platform for supporting generators of power derived from the wind and/or the waves and/or ocean currents, wherein the floating platform adopts an approximately disc-shaped general configuration with a circular or polygonal perimeter, wherein the disc has a height or depth (13) and a diameter (14), where the floating platform presents a ratio between the platform height or depth (13) and diameter (14) thereof of between 0.06 and 0.35.

2. A floating platform for supporting generators of power derived from the wind and/or the waves and/or ocean currents, as claimed in claim 1, wherein the floating platform has an external shell or external sheathing (20) whose internal structure consists of a series of radially-disposed carlings (22), connected by means of a series of stringers (23) to endow the platform with a greater structural rigidity, and in addition, a series of transversal perimeter reinforcements (24), such as angular profiles or bulb flats, which stiffen the external sheet panels.

3. A floating platform for supporting generators of power derived from the wind and/or the waves and/or ocean currents, as claimed in claim 1, wherein the floating platform has additional complementary elements, consisting of a number of bulwarks (15) acting as breakwaters, whose purpose is to improve its behaviour against the swell that may affect the perimeter of the platform.

4. A floating platform for supporting generators of power derived from the wind and/or the waves and/or ocean currents, as claimed in claim 1, wherein the floating platform has additional complementary elements, consisting of a keel (16) acting as a skirt, to improve its behaviour against the swell.

5. A floating platform for supporting generators of power derived from the wind and/or the waves and/or ocean currents, as claimed in claim 1, wherein the platform has a number of power generators driven by the waves and currents coupled to the platform, consisting of devices designed for this purpose, either with vertical-shaft rotors (waves) or horizontal-shaft (currents), or other devices which, located on the periphery of the platform at the height of the waterline, enable the collection of the energy foreseen to be performed.

6. A floating platform for supporting generators of power derived from the wind and/or the waves and/or ocean currents, as claimed in claim 1, wherein the platform is constructed from Steel, Marine Steel A or glass-fibre reinforced polyester (GRP).

7. A floating platform for supporting generators of power derived from wind and/or waves and/or ocean currents, as claimed in claim 1, wherein the floating platform has one, or a combination, of the following features:
Equipment that enables rotor blades to alter their pitch according to the intensity of the wind;
Automatic means for taking on or releasing of seawater ballast to position a tilt of the platform in the direction where wind is coming from at all times;
Cathodic protection means by impressed currents to prevent oxidation of a hull and to maintain protection throughout a useful life of the platform;
Means for monitoring of a tension of anchor chains for remote detection of faults or maladjustments; and
A weather station.
